(19) United States
(12) Patent Application Publication
(10) Pub. No.: US 2016/0292966 A1
(43) Pub. Date: Oct. 6, 2016

(54) SYSTEM AND METHOD OF PROVIDING A VIRTUAL SHOPPING EXPERIENCE

(71) Applicant: Gary Denham, Palm Springs, CA (US)

(72) Inventor: Gary Denham, Palm Springs, CA (US)

(21) Appl. No.: 15/086,991

(22) Filed: Mar. 31, 2016

Related U.S. Application Data
(60) Provisional application No. 62/140,608, filed on Mar. 31, 2015.

(51) Int. Cl. G07F 17/32; G06Q 30/06

(52) U.S. Cl. CPC G07F 17/3244; G06Q 30/0633; G06Q 30/0643

(57) ABSTRACT

A system and method of providing a virtual shopping experience including virtual environment module over a computerized network; wherein a plurality of users are able to navigate an virtual environment each using an avatar by operation of a graphical user interface. The system includes a virtual object module that manages a plurality of virtual objects displayed in the virtual environment; wherein the plurality of virtual objects includes a plurality of user avatars and product avatars associated with a shopping cart module. The system includes a virtual location module that manages the location of the plurality of virtual objects displayed in the virtual environment. The system includes an audio control module that manages associated audio media with the plurality of virtual objects and the virtual locations; wherein the audio media module plays audio media associated with the plurality of virtual objects.

### CROSS-REFERENCE TO RELATED APPLICATIONS

This invention claims priority, under 35 U.S.C. §120, to the U.S. Provisional Patent Application No. 62/140,608 to Gary Denham filed on Mar. 31, 2015, which is incorporated by reference herein.

### BACKGROUND OF THE INVENTION

1. Field of the Invention

The present invention relates to virtual worlds over a computerized network, specifically a system and method of providing a virtual shopping experience.

2. Description of the Related Art

A virtual world or massively multiplayer online world (MMOW) is a computer-based simulated environment populated by many users who may create a personal avatar, and simultaneously and independently explore the virtual world, participate in its activities and communicate with others. These avatars may be textual, two or three-dimensional graphical representations, or live video avatars with auditory and touch sensations. In general, virtual worlds allow for multiple users.

The user accesses a computer-simulated world which presents perceptual stimuli to the user, who in turn may manipulate elements of the modeled world and thus experience a degree of presence. Such modeled worlds and their rules may draw from the reality or fantasy worlds. Example rules are gravity, topography, locomotion, real-time actions, and communication. Communication between users may range from text, graphical icons, visual gesture, sound, and rarely, forms using touch, voice command, and balance senses.

A virtual economy is the emergent property of the interaction between participants in a virtual world. While the designers have a great deal of control over the economy by the encoded mechanics of trade, it is nonetheless the actions of players that define the economic conditions of a virtual world. The economy arises as a result of the choices that players make under the scarcity of real and virtual resources such as time or currency. Participants have a limited time in the virtual world, as in the real world, which they must divide between task such as collecting resources, practicing trade skills, or engaging in less productive fun play. The choices they make in their interaction with the virtual world, along with the mechanics of trade and wealth acquisition, dictate the relative values of items in the economy.

The economy in virtual worlds is typically driven by in-game needs such as equipment, food, or trade goods. Virtual economies like that of Second Life, however, are almost entirely player-produced with very little link to in-game needs. While the relevance of virtual world economics to physical world economics has been questioned, it has been shown the users of virtual worlds respond to economic stimuli (such as the law of supply and demand) in the same way that people do in the physical world. In fact, there are often very direct corollaries between physical world economic decisions and virtual world economic decisions, such as the decision by prisoners of war in World War II to adopt cigarettes as currency and the adoption of Stones of Jordan as currency in Diablo II.

The value of objects in a virtual economy is usually linked to their usefulness and the difficulty of obtaining them. The investment of real world resources (time, membership fees, etc.) in acquisition of wealth in a virtual economy may contribute to the real world value of virtual objects. This real world value is made obvious by the trade of virtual items on online market sites like eBay, PlayerUp, IGE for wow gold. Recent legal disputes also acknowledge the value of virtual property, even overriding the mandatory EULA which many software companies use to establish that virtual property has no value and/or that users of the virtual world have no legal claim to property therein.

Some industry analysts have moreover observed that there is a secondary industry growing behind the virtual worlds, made up by social networks, websites and other projects completely devoted to virtual worlds communities and gamers. Special websites such as GamerDNA, Koinup and others which serve as social networks for virtual worlds users are facing some crucial issues as the DataPortability of avatars across many virtual worlds and MMORPGs. Virtual worlds offer advertisers the potential for virtual advertisements, such as the in-game advertising already found in a number of video games.

Some improvements have been made in the field. Examples of references related to the present invention are described below in their own words, and the supporting teachings of each reference are incorporated by reference herein:

U.S. Pat. No. 8,606,642, issued to Siounis et al., discloses a computer-implemented method of enabling remote and/or a virtual shopping of an actual retail store is disclosed. Software provides a means of creating custom, electronic shopping mall configurations that may include a plurality of participating retail stores, each of which may be selected from a list of participating retailers. The mall's stores and walkways may be selectable to launch a remote/virtual shopping experience. Navigation is by moving a cursor to browse for desired merchandise. Remote shopping is achieved through the use of a plurality of cameras at participating stores to provide live streaming images of store merchandise for remote shopping, or a series of recorded images that permit virtual shopping. All images may be embedded with merchandise information. Holding the cursor over a merchandise image may reveal embedded information. Views obstructed by a live shopper in the live streaming image may be supplanted by the beginning-of-day stored images.

U.S. Pat. No. 7,680,694, issued to Glazer et al., discloses a solution is provided for a method for a user to shop online in a three dimensional (3D) virtual reality (VR) setting by receiving a request at a shopping server to view a shopping location, having at least one store, and displaying the shopping location to the user's computer in a 3D interactive simulation view via a web browser to emulate a real-life shopping experience for the user. The server then obtains a request to enter into one of the stores and displays the store website to the user in the same web browser. The store website has one or more enhanced VR features. The server then receives a request to view at least one product and the product is presented in a 3D interactive simulation view to emulate a real-life viewing of the product.

U.S. Patent Application Publication No.: 2010/0030578, by Siddique et al., discloses methods and systems described herein relate to online methods of collaboration in community environments. The methods and systems are related to an online apparel modeling system that allows users to have three-dimensional models of their physical profile created. Users may purchase various goods and/or services and collaborate with other users in the online environment.

U.S. Patent Application Publication No.: 2010/0005424, by Sundaresan et al., discloses A system and method for creating a virtual world for supporting a consumer experience is disclosed. The apparatus in an example embodiment includes providing access to a database of item listing categories, each item listing category in the database having an associated link to a source for physical items corresponding to the item listing category; generating an image of a virtual store in a three-dimensional (3D) virtual environment; populating the virtual store with at least one first object representing an item listing category; receiving a signal indicative of user interaction with the at least one first object; and using the associated link to re-direct the user to the source for physical items corresponding to the item listing category represented by the at least one first object with which the user interacted.

U.S. Patent Application Publication No.: 2010/0205043, by Edwards, discloses Embodiments of the invention include a virtual reality system that includes an instrumented device used to present a virtual shopping environment to a simulation participant. The participant's interactions with the virtual shopping environment may be used to conduct market research into the consumer decision making process. The virtual shopping environment may include one or more smart objects configured to be responsive to participant interaction. The virtual shopping environment may recreate a real-world shopping environment.

The inventions heretofore known suffer from a number of disadvantages which include not being easy, not being fun, not adding elements of realism, failing to be interactive, failing to be intuitive, not being interesting, not allowing for community interaction while shopping through proximity with friends, failing to improve confidence in purchases, resulting in too many product returns, not increasing purchase satisfaction, and failing to provide sufficient consumer information.

What is needed is a system and method of providing a virtual shopping experience that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods of providing a virtual shopping experience. Accordingly, the present invention has been developed to provide an efficient and effective system and method of providing a virtual shopping experience.

According to one embodiment of the invention, there is a method of providing a virtual shopping experience. The method may include the step of providing a virtual environment over a computerized network. A plurality of users may be able to navigate therein each using an avatar by operation of a graphical user interface.

The method of providing a virtual shopping experience may include the step of populating the virtual environment with a plurality of virtual objects at virtual locations. The plurality of virtual objects may include a plurality of user avatars and product avatars associated with a shopping cart module. The step of populating the virtual environment may include the step of providing a store creation module that creates a plurality of objects at virtual locations. The store creation module may convert 2D images to 3D representational images displayed as product avatars.

The method of providing a virtual shopping experience may include the step of associating audio media with the plurality of virtual objects and the virtual locations thereby generating associated audio media. The audio media may include audio files and streaming audio data.

The method of providing a virtual shopping experience may include causing associated audio media to play over a speaker with a play characteristic thereof determined by a relation between a virtual location of an object associated with the associated media and a virtual location of an avatar of the user. The play characteristics may be selected from the group of characteristics consisting of: volume, pitch modulation, play speed, tone, and reverberation. The relation between a virtual location of an object associated with the associated audio media and a virtual location of an avatar of the user may be an inverse square of a total distance there between. The relation between a virtual location of an object associated with the associated audio media and a virtual location of an avatar of the user may be a determination as to whether each are in the same virtual zone.

According to one embodiment of the invention, there is a system of providing a virtual shopping experience. The system may include a virtual environment module over a computerized network; wherein a plurality of users may be able to navigate a virtual environment each using an avatar by operation of a graphical user interface.

The system of providing a virtual shopping experience may include a virtual object module in communication with the virtual environment module; wherein the virtual object module may manage a plurality of virtual objects displayed in the virtual environment; wherein the plurality of virtual objects may include a plurality of user avatars and product avatars associated with a shopping cart module.

The system of providing a virtual shopping experience may include a virtual location module in communication with the virtual environment module; wherein the virtual location module may manage the location of the plurality of virtual objects displayed in the virtual environment.

The system of providing a virtual shopping experience may include an audio control module in communication with the virtual environment module; wherein the audio control module may manage associated audio media with the plurality of virtual objects and the virtual locations; wherein the audio media module may play audio media associated with the plurality of virtual objects in the virtual environment over a speaker with a play characteristic determined by a relation between a virtual location of an object associated with the associated media and a virtual location of an avatar of the user; wherein the audio media may include audio files and streaming audio data. The play characteristic may be selected from the group of characteristics consisting of: volume, pitch modulation, play speed, tone, and reverberation. The relation between a virtual location of an object associated with the associated audio media and a virtual location of an avatar of the user may be an inverse square of a total distance there between. The relation between a virtual location of an object associated with the associated audio media and a virtual location of an avatar of the user may be a determination as to whether each are in the same virtual zone.

The system of providing a virtual shopping experience may include a store creation module that may create a plurality of objects at virtual locations within the virtual environment; wherein the store creation module may convert 2D images to 3D representational images displayed as product avatars.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a system of providing a virtual shopping experience, according to one embodiment of the invention;

FIG. 2 is an exemplary screenshot of a virtual interaction environment, according to one embodiment of the invention;

FIG. 3 is an exemplary screenshot of a virtual shopping environment, according to one embodiment of the invention;

FIG. 4 is a module diagram of a virtual shopping experience system, according to one embodiment of the invention;

FIG. 5 is a module diagram of a virtual environment module, according to one embodiment of the invention;

FIG. 6 is a module diagram of an audio control module, according to one embodiment of the invention;

FIG. 7 is a module diagram of a store creation module, according to one embodiment of the invention; and

FIG. 8 is a flowchart of a method of providing a virtual shopping experience, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Android, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

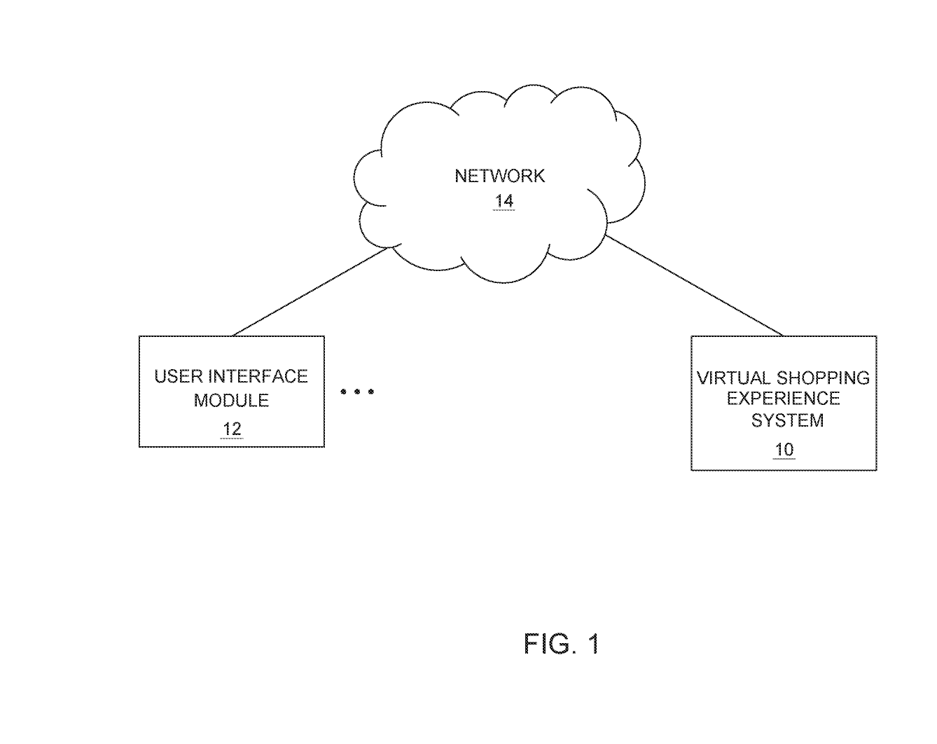

FIG. 1 is a network diagram of a system of providing a virtual shopping experience, according to one embodiment of the invention. There is shown a virtual shopping experience system 10 in communication with a plurality of user interface modules 12 over a computerized network 14.

The illustrated virtual shopping experience system 10 is in communication with a plurality of user interface modules 12 over a computerized network 14. The plurality of users interface modules 12 interact with each other through a virtual environment, generated by the virtual shopping experience system 10, using avatars that may be personalized or customized. The virtual shopping experience system 10 provides a virtual environment/world having a virtual shopping and virtual interaction capabilities; wherein users, through the user interface modules 12 and the avatars, interact and socialize with each other in the virtual environment. The virtual shopping experience system 10 provides a virtual shopping environment over a computerized network 14, wherein the virtual shopping environment resembles an actual shopping mall or shopping environment in the real world.

The virtual shopping environment provided by the virtual shopping experience system 10 provides a virtual shopping environment for a user or a plurality of users/friends shop and interact together without leaving their home, through an avatar. The virtual shopping environment resembles a real world shopping environment, wherein the avatar actually pushes or uses a shopping cart to shop and store items for purchase through the virtual shopping environment. The virtual shopping environment includes virtual stores including virtual products and virtual objects, wherein the users navigate through the virtual stores and virtual products and objects. The virtual products includes product descriptions, pricing, and images for the user/avatar to browse and compare with other virtual products.

The virtual shopping experience system 10 provides a virtual interaction environment that may be part of, or separate, from the virtual shopping environment. The virtual interaction environment includes parental controls for underage users, wherein the parental controls enable a parent to control who the underage users interact with. In particular, underage users may not interact with users out of their age group or users that the underage users do not know. The virtual interaction environment provides an environment for avatars to gather and communicate with each other. The virtual interaction environment resembles the real world, wherein users/avatar within a proximity of each other may hear the other users/avatars conversation.

According to one embodiment of the invention, there is a virtual shopping experience system 10 including a combination of a social network and a shopping mall experience where users may log in and hang out with friends. The users may talk with their friends on headsets if they want, instead of typing in chat boxes. The user has a custom built avatar that may walk through virtual stores in a virtual mall, in a virtual environment while looking at virtual products or objects on virtual shelves. The user may buy these products and have the items delivered in the real world. The auditory experience is realistic sound such that while people are talking far away the sound will be far away, or quieter, and if the people are talking close by, the sounds are louder, like in a real world environment through a virtual environment. Communications and proximity regarding products may be monitored and such may trigger changes in the system, such as but not limited to altering an audio characteristic, playing an audio clip, altering a video/image characteristics, displaying an image, playing a video clip, presenting a dialog box, and the like and combinations thereof.

The illustrated user interface modules 12 are in communication with the virtual shopping experience system 10 over a computerized network 14. The user interface module 12 may be a graphical user interface module and may include devices and programming sufficient to communicate with a network and the virtual shopping experience system 10, to display user data, environment data, avatar data, shopping data, merchant data, communication data, consumer data, and marketing data. Generally, such may be in the form of a personal computer, dumb-terminal, smartphone, tablet, or the like, but other embodiments are contemplated. Such will generally include a processor, a display device (e.g. monitor, tv, touchscreen), an audio device (e.g. speaker, microphone), memory, a bus, a user input device (e.g. controller, keyboard, mouse, touchscreen), and a communication device (e.g. a network card, wireless transponder), each in communication with one or more of the others as appropriate for the function thereof, generally over the bus. There may be a plurality and a variety of such graphical user interface modules in communication with the system over the network, with some being for users, merchants, other consumers, marketers, etc. and combinations thereof.

The user interface module 12 is configured to provide one or more interfaces for accessing the computerized system 10 over a computerized network 14. Such may include one or more graphical user interfaces that may be embodied in software instructions for controlling display on a display (such as but not limited to a TV, monitor, cell phone/tablet screen, etc.) and/or for routing signals from an input device (such as but not limited to a keyboard, touchscreen, mouse, etc.) such that a user may perform data entries or queries in the computerized system, suggestions or recommendations, and receive data information therefrom. Such may be embodied in one or more user interfaces that permit browsing of the computerized system. Such may be embodied in one or more user interfaces that permit service personnel or administrators to make adjustments, changes, and otherwise provide product data or product updates to the computerized system. Such may be embodied in one or more user interfaces that permit review of data from the system, such as but not limited to template data, product data, user and consumer data, management data, etc.

In one non-limiting embodiment, there is a navigable virtual environment having at least one virtual 3D store with 3D shelving displaying 3D products. Such 3D display may be by 3D mapping onto a 2D display, such as is done with typical MMORPG games, first person shooters and the like, and/or it may be through a 3D/holographic display. Such a virtual environment also includes a store creation module that facilitates creation, by a merchant, of a virtual 3D store with 3D shelving that displays 3D products. A navigable virtual environment may provide a 3D audio experience to users therein, wherein sounds virtually emanating from a virtual object (e.g. another avatar, a product on a shelf, a storefront) sound louder/softer based on the distance in the virtual environment that the avatar is from such sources. The user may be able to make selections to adjust how sounds operate and may be able to differentially set such settings based on sound categories, such as but not limited to sounds from objects (e.g. 3D objects), avatars, stores, virtual locations, triggered events, and the like and combinations thereof and such selections may include but are not limited to realistic distance settings, always audible, never audible, inverted distance settings (i.e. the sound is louder the further you are from the source), randomized, limits on how often or how many times a sound may be generated, and the like and combinations thereof. A user may be provided with sound settings that relate to their avatar and/or any objects, locations and/or triggered events associated therewith, such that the user's settings on the same are applied to sound experiences by others within the virtual world/environment (e.g. it may override sound settings (or just default sound settings, but may be able to be overridden by the users themselves) by other avatars.

A store creation module may include settings that may determine default audio settings for objects/avatars/triggered events/locations within or otherwise associated with the store, such as but not limited to selections to adjust how sounds operate and may be able to differentially set such settings based on sound categories, such as but not limited to sounds from objects (e.g. 3D objects), avatars, stores, virtual locations, triggered events, and the like and combinations thereof and such selections may include but are not limited to realistic distance settings, always audible, never audible, inverted distance settings (i.e. the sound is louder the further you are from the source), randomized, limits on how often or how many times a sound may be generated, and the like and combinations thereof.

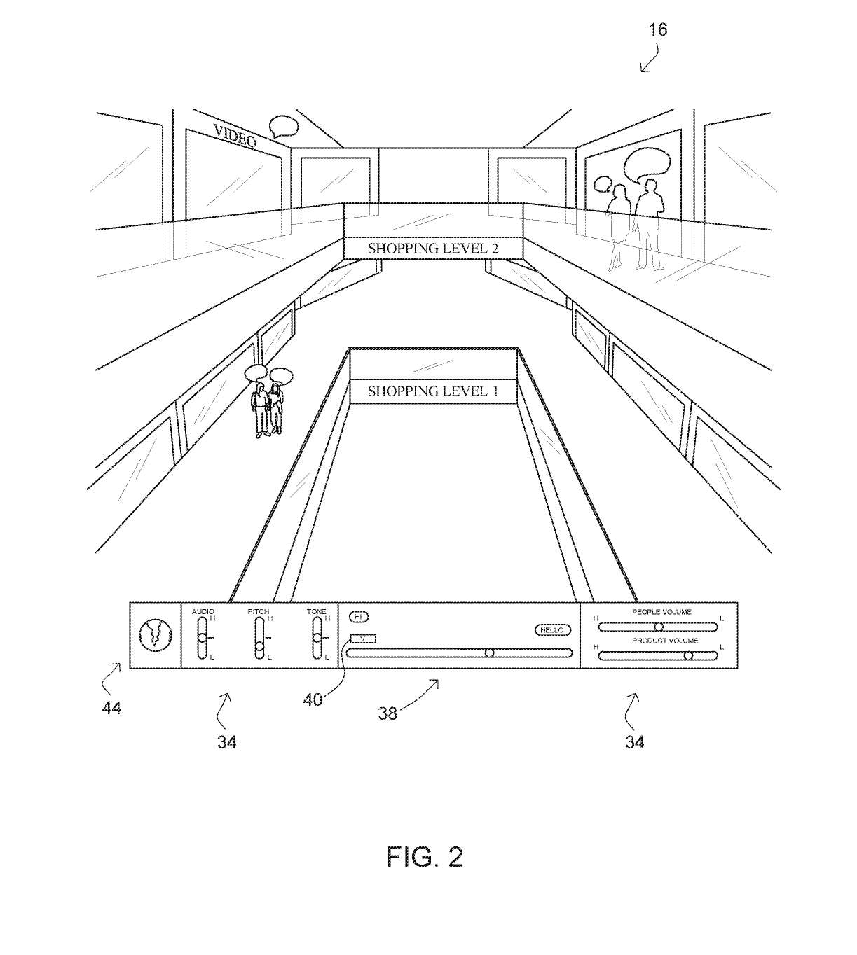

FIG. 2 is an exemplary screenshot of a virtual interaction environment, according to one embodiment of the invention. There is shown a virtual interaction environment 16 generated by a virtual shopping experience system over a computerized network.

The illustrated virtual interaction environment 16 enables a user to navigate the virtual interaction environment and interact with other avatars and users. The virtual interaction environment 16 is generated and monitored by a virtual shopping experience system over a computerized network. The illustrated exemplary screenshot shows a broad overview of a virtual interaction environment 16, such as a multi-level shopping mall, including a plurality of users interacting with each other, by the use of avatars, over a computerized network. While navigating through the virtual interaction environment 16 conversations and sounds may be become louder or quieter depending on the relative location of the user's avatar. In addition, the user may adjust or filter out unwanted or wanted sounds while navigating through the virtual interaction environment 16 by an audio control module 34, enabling the user to adjust sound and sound characteristics of people, product, or stores in the virtual interaction environment 16. In addition, the user may chat with other users or friends while navigating the virtual interaction environment 16 by a text chat module 38 or a video chat module 40. The text chat module 38 and the video chat module 40 each enable a user, through a user interface module over a computerized network, to interact with other users of the system. Furthermore, the illustrated virtual interaction environment 16 includes a world server module 44 to enable a user to visit other virtual interaction environments over a computerized network throughout the world.

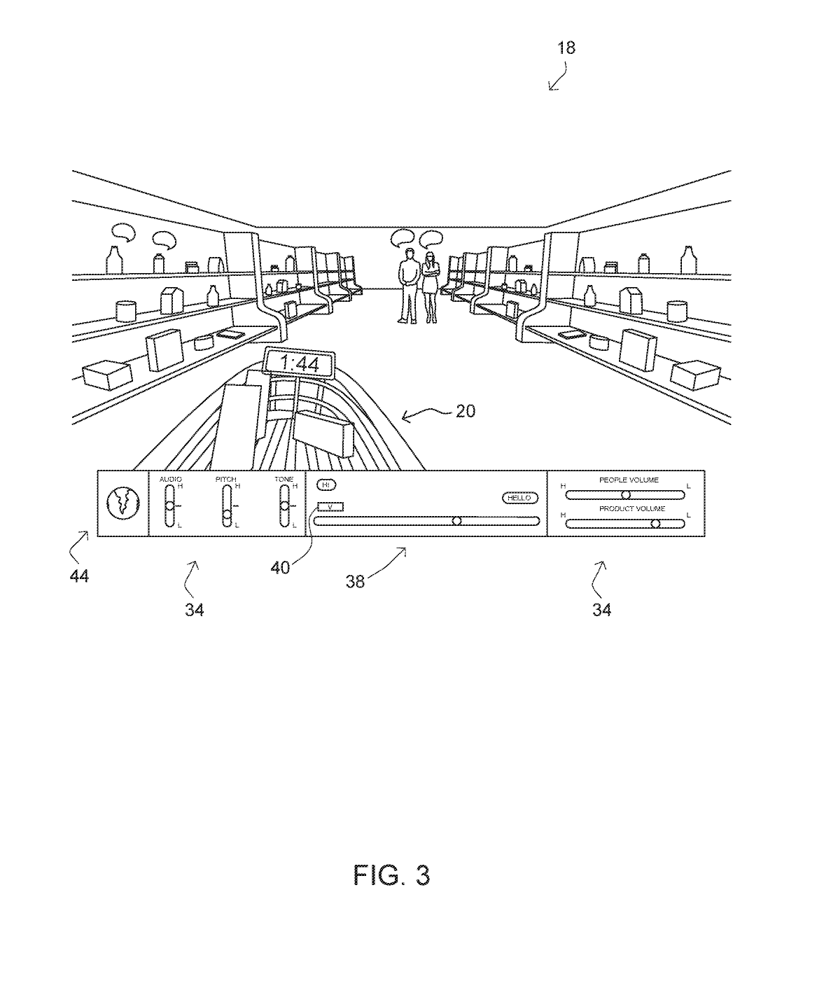

FIG. 3 is an exemplary screenshot of a virtual shopping experience, according to one embodiment of the invention. There is shown a virtual shopping environment 18 generated by a virtual shopping experience system over a computerized network.

The illustrated virtual shopping environment 18 enables a user to navigate a virtual store in a virtual environment for virtual products that may represent actual products and objects available for purchase. The illustrated virtual shopping environment 18 shows a user pushing a shopping cart module 20 including products or objects, disposed within the shopping cart module, the user wishes to purchase at the end of shopping. The products or objects may be delivered to the user's physical location after purchase. While navigating through the virtual shopping environment 18 conversations and sounds may be become louder or quieter depending on the relative location of the user's avatar. In addition, the user may adjust or filter out unwanted or wanted sounds while navigating through the virtual interaction environment 18 by an audio control module 34; wherein the volume, pitch, and tone may be adjusted along with filtering people conversation volume. Furthermore, the user may adjust or filter out unwanted or wanted sounds from products or objects while navigating the virtual shopping environment, such as an advertisement for a product or brief summary of the product. In addition, the user may chat with other users or friends while navigating the virtual shopping environment 18 by a text chat module 38 or a video chat module 40. The text chat module 38 and the video chat module 40 each enable a user, through a user interface module over a computerized network, to interact with other users of the system. Furthermore, the illustrated virtual shopping environment 18 includes a world server module 44 to enable a user to visit other virtual shopping environments over a computerized network throughout the world.

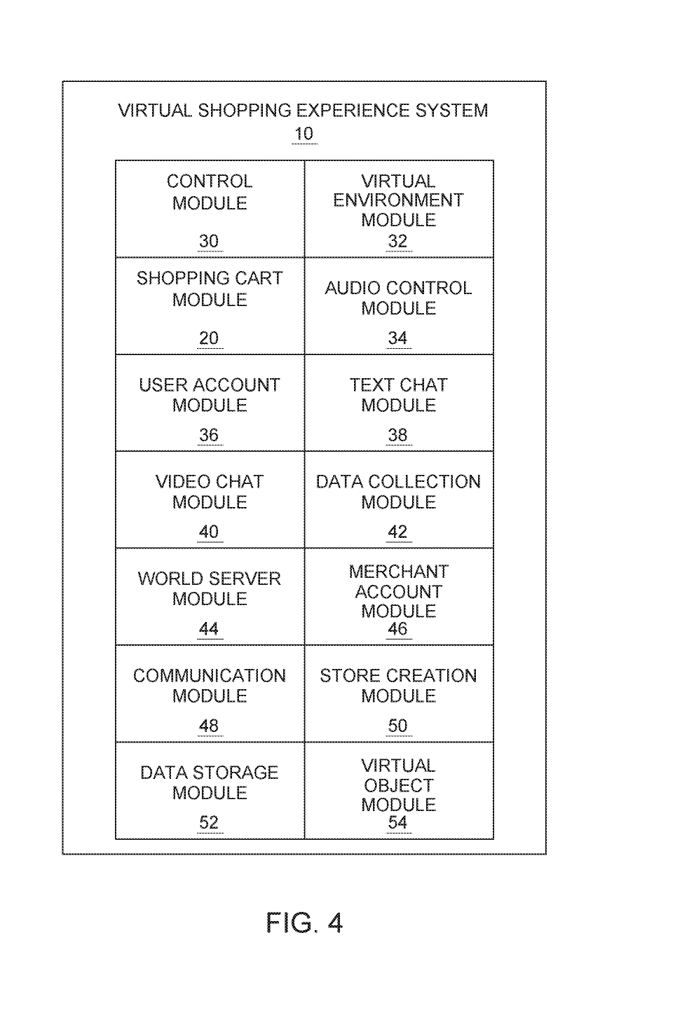

FIG. 4 is a module diagram of a system of providing a virtual shopping experience, according to one embodiment of the invention. There is shown a virtual shopping experience system 10 including a control module 30, a virtual environment module 32, a shopping cart module 20, an audio control module 34, an user account module 36, a text chat module 38, a video chat module 40, a data collection module 42, a world server module 44, a merchant account module 46, a store creation module 50, a data storage module 52 and a communication module 48. The illustrated modules and/or others not illustrated but described or implied herein are in communication with each other to the degree and as appropriate to perform their respective and/or collective functions and may be in communication over one or more networks, data busses, memory locations and the like and combinations thereof.

The illustrated virtual shopping experience system 10 includes a control module 30 that provides operational instructions and commands to the modules and components of the system. The control module 30 is in communication with the modules and components of the system 10 (and/or other modules described herein) and provides managerial instructions and commands thereto. The source of such instructions/commands may be from one or more other modules described herein and/or through interactions between one or more other modules described herein. The control module 30 sets parameters and settings for each module and component of the system 10. In addition, the control module 30 may include a processor for managing and processing data transferred through the system 10. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated virtual shopping experience system 10 includes a communication module 48, such as a network card, system bus, or wireless communication module, and communicates with a computerized network. The communication module 48 provides communication capabilities, such as wireless communication, to the modules and components of the system 10 and the components and other modules described herein. The communication module 48 provides communication between a wireless device, such as a mobile phone, and a computerized network and/or to facilitate communication between a mobile device and other modules described herein. The communication module 48 may have a component thereof that is resident on a user's mobile device or on a user's desktop computer. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated virtual shopping experience system 10 includes a data storage module 52 in communication with the modules and components of the system 10. The data storage module 52 stores data for each of the modules of the system 10. The data storage module 52 is in communication with the various modules and components of the system 10 and stores data transferred there through. The data storage module 52 stores data transferred through each of the modules of the system 10, thereby updating the system 10 with up to date data and real time user and product data. The data storage module 52 securely stores user data and product data along with data transferred through the system 10. Data storage modules may be databases and/or data files and the memory storage device may be, but is not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated virtual shopping experience system 10 includes a virtual environment module 32 in communication with the modules and components of the system 10. The virtual environment module 32 provides a virtual shopping environment along with a virtual interaction environment, wherein the shopping and interaction environments may overlap or may be separate from each other. The virtual environment module 32 provides a virtual shopping environment that resembles a shopping mall having a plurality of merchant stores including a plurality of products or objects available for purchase. The virtual environment module 32 provides a virtual interaction environment, wherein users, through the use of avatars, interact with each other in a virtual environment. Non-limiting examples of a virtual environment module may be a 3D environment as described in U.S. Patent Publication No.: 2012/0179983 by Lemire or U.S. Patent Publication No.: 2014/0315169 by Bohbot, which are incorporated for their supported herein.

The illustrated virtual shopping experience system 10 includes a user account module 36 in communication with the modules and components of the system 10 and is configured to manage and store personal user, avatar, purchasing, and shopping settings, preferences, and parameters for use with the virtual shopping experience system 10. The user account module 36 is configured to store user metadata and avatar data, based upon user input. Non-limiting examples of a user account module may be a user account including demographic information about a user as well as preference information about a user that is associated therewith. Such information may include preferred clothing measurements, goals, and the like and combinations thereof. Such may be embodied in a database or other data structure/hierarchy such that the data associated with each user may be used by one or more modules described herein and/or may be altered and/or added to by one or more modules described herein. The user account module 36 is configured to store personal and financial data relating to the virtual shopping experience system 10. Non-limiting examples of a user account module may be an account management module as described in U.S. Patent Publication No.: 2003/0014509; or a management module as described in U.S. Pat. No. 8,265,650, which are incorporated for their supporting teachings herein.

The illustrated virtual shopping experience system 10 includes an audio control module 34 in communication with the modules and components of the system 10. The audio control module 34 provides audio controls to each individual user, wherein a user is shopping through the virtual shopping environment, they may be listening to music or commentary of their choice. The audio control module 34 is in communication with a user's music library, wherein the user chooses songs or playlist to listen to while interacting or shopping through the virtual shopping experience system. In addition, while the user navigates the virtual shopping environment or the virtual interaction environment, the audio control module 34 enables the user to adjust the volume, pitch, or tone of people or products within the virtual environments. Furthermore, the user may also filter out people or product volume with the audio control module 34. Non-limiting examples of an audio control module may be an audio control module as described in U.S. Patent Publication No.: 2013/0201397 by Ayoub et al. or U.S. Patent Publication No.: 2008/0309830 by Motomura, which are incorporated for their supported herein.

The illustrated virtual shopping experience system 10 includes a shopping cart module 20 in communication with the modules and components of the system 10. The shopping cart module 20 includes a purchase module configured to facilitate purchase of products through the virtual shopping environment of the system 10. The shopping cart module 20 may include P.O.S. systems, inventory systems, customer service systems, customer account tracking systems, buyer reward systems, and the like and combinations thereof. Such systems may provide real-time information about purchases and non-purchases or may update on particular occasions. The shopping cart module 20 is configured to store purchasing data associated with the user. Non-limiting examples of a shopping cart module may be a purchase module as described in U.S. Patent Publication No.: 2010/0179846, by Best et al.; or a purchase module as described in U.S. Patent Publication No.: 2010/0094726, by Tuli; wherein these examples are incorporated for their supported teachings herein.

The illustrated virtual shopping experience system 10 includes a text chat module 38 in communication with the modules and components of the system 10. The text chat module 38 provides text chatting and interacting capabilities to the user of the system 10 through a virtual interaction environment or a virtual shopping environment. The text chat module 38 provides instant messaging capabilities to the user of the system 10, wherein a user may send messages, pictures, and product descriptions to other users, over a computerized network. Non-limiting examples of a text chat module may be a system as described in U.S. Pat. No. 8,701,020, issued to Fulcher et al. or a chat system as described in U.S. Patent Publication No.: 2008/0059580 by Kalinowski et al., which are incorporated for their supported herein.

The illustrated virtual shopping experience system 10 includes a video chat module 40 in communication with the modules and components of the system 10. The video chat module 40 provides video chat capabilities to the user of the system 10, through a virtual interaction environment or a virtual shopping environment. The video chat module 40 allows users to interact and communicate with each other, without having to type or text. The video chat module 40 allows a user to see and hear another user or users, over a computerized network, and vice versa. Non-limiting examples of a video chat module may be a system as described in U.S. Pat. No. 8,701,020, issued to Fulcher et al. or a video chat system as described in WO2002/029513 by Linfu et al., which are incorporated for their supported herein.

The illustrated virtual shopping experience system 10 includes a data collection module 42 in communication with the modules and components of the system 10. The data collection module 42 automatically collects data on the user, products, merchants, social interactions, etc. and stores the data therein or in a data storage module. The data collection module 42 is in communication with the plurality of user interface modules and the modules and components of the system 10. The data collection module 42 is configured to collect and store data for each of the plurality of user interfaces and each user account associated therewith. The data collection module 42 is in communication with the various modules and components of the system 10 and configured to store data transferred there through. The data collection module 42 is configured to store data transferred through each of the user interface modules, thereby updating the system 10 with up to data and real time product data. The data collection module 42 is configured to securely store shopping and financial data associated with the user or user account data along with data transferred therethrough. Data collection modules may be databases or data files and the memory storage device may be hard drives or tapes. A non-limiting example of a data base is Filemaker Pro 11, manufactured by Filemaker Inc., 5261 Patrick Henry Dr., Santa Clara, Calif., 95054. Non-limiting examples of a data collection module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated virtual shopping experience system 10 includes a world server module 44 in communication with the modules and components of the system 10. The world server module 44 provides a user the capability of browsing different types and groups of shopping environments. The world server module 44 may include a sports world, wherein a user shops and browses only sports related merchant stores through a virtual environment. The world server module 44 allows a user to change and select different genres, categories, and related products quickly and easily through the virtual environment. Such may be accomplished by use of one or more servers hosting a plurality of virtual environments, such as but not limited to how MMORPG servers host a plurality of zones/worlds but includes selections that a user may utilize to customize what their “world” includes. Such a server or server bank may dynamically generate virtual environments for individual users and/or user groups based on such selections and may offer images, sounds, videos, avatar options, store views, virtual store selections (e.g. by genre, industry, category), environmental effects and the like that correspond with such selections. Non-limiting examples of a world server module may be a system as described in U.S. Pat. No. 8,407,218, issued to Barlin et al. or U.S. Pat. No. 8,117,081, issued to Raccah et al., which are incorporated for their supported herein.

The illustrated virtual shopping experience system 10 includes a merchant account module 46 in communication with the modules and components of the system 10. The merchant account module 46 is configured to manage and store merchant and product settings, preferences, and parameters for use with the virtual shopping experience system. The merchant account module 46 is configured to store consumer metadata and user data, based upon user interaction through a virtual merchant store. Non-limiting examples of a merchant account module may be an account management module as described in U.S. Patent Publication No.: 2003/0014509; or a management module as described in U.S. Pat. No. 8,265,650, which are incorporated for their supporting teachings herein.

The illustrated virtual shopping experience system 10 includes a store creation module 50 in communication with the modules and components of the system 10. The store creation module 50 provides a merchant the capabilities to create a virtual storefront including virtual products to be displayed therein. The store creation module 50 enables a merchant to create an online virtual store for avatars to browse and shop there through. The store creation module 50 enables a merchant to upload products available for purchase through the virtual shopping environment. The store creation module 50 enables a merchant to create and store product data associated with products available for purchase through the virtual shopping experience system 10. Non-limiting examples of a store creation module may be a system as described in U.S. Patent Publication No.: 2006/0271460 by Hanif or a system as described in WO 2012/075589 by Azba, which are incorporated for their supported herein.

The illustrated system of providing a virtual shopping experience 10 includes a virtual environment module 32 over a computerized network; wherein a plurality of users are able to navigate a virtual environment each using an avatar by operation of a graphical user interface.

The system of providing a virtual shopping experience 10 includes a virtual object module 54 in communication with the virtual environment module 32; wherein the virtual object module 54 manages a plurality of virtual objects displayed in the virtual environment. The plurality of virtual objects includes a plurality of user avatars and product avatars associated with a shopping cart module 20.

The system of providing a virtual shopping experience 10 includes the virtual environment module 32 having a virtual location module in communication with the virtual environment module 32. The virtual location module manages the location of the plurality of virtual objects displayed in the virtual environment.

The system of providing a virtual shopping experience 10 includes an audio control module 34 in communication with the virtual environment module 32. The audio control module 34 manages associated audio media with the plurality of virtual objects and the virtual locations. The audio control module 34 plays audio media associated with the plurality of virtual objects in the virtual environment over a speaker with a play characteristic determined by a relation between a virtual location of an object associated with the associated media and a virtual location of an avatar of the user. The audio media includes audio files and streaming audio data. The play characteristic is selected from the group of characteristics consisting of: volume, pitch modulation, play speed, tone, and reverberation. The relation between a virtual location of an object associated with the associated audio media and a virtual location of an avatar of the user is an inverse square of a total distance there between. The relation between a virtual location of an object associated with the associated audio media and a virtual location of an avatar of the user is a determination as to whether each are in the same virtual zone.

The system of providing a virtual shopping experience 10 includes a store creation module 50 that creates a plurality of objects at virtual locations within the virtual environment. The store creation module 50 converts 2D images to 3D representational images displayed as product avatars.

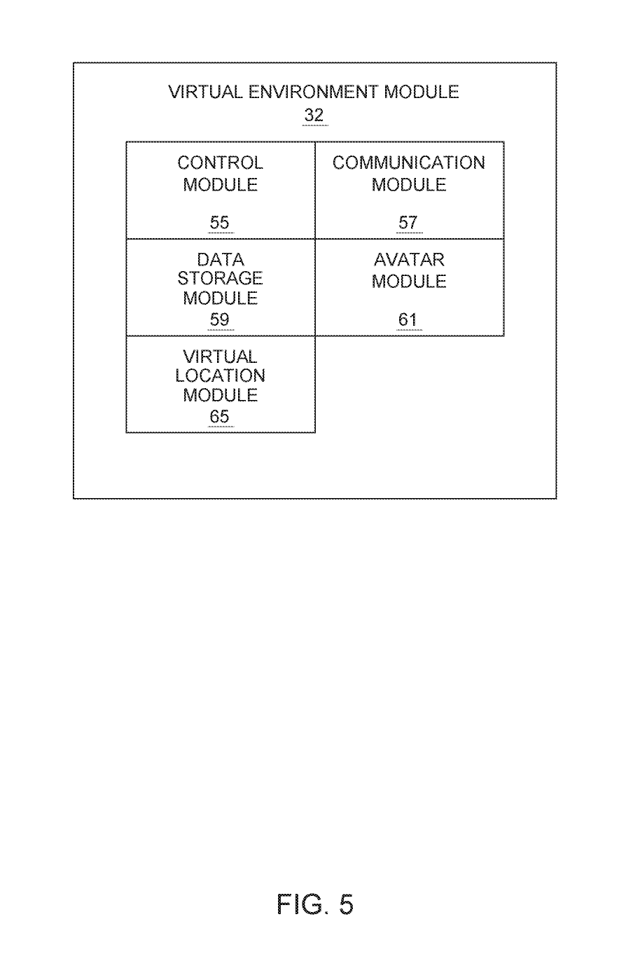

FIG. 5 is a module diagram of a virtual environment module, according to one embodiment of the invention. There is shown a virtual environment module 32 including a control module 55, a communication module 57, a data storage module 59, a virtual location module 65, and an avatar module 61.

The illustrated virtual environment module 32 manages the location of the plurality of virtual objects displayed in the virtual environment. The virtual environment module 32 includes a control module 55 that provides operational instructions and commands to the modules and components of the virtual environment module 32. The control module 55 is in communication with the modules of the virtual environment module 32 and provides managerial instructions and commands thereto. The source of such instructions/commands may be from one or more other modules described herein and/or through interactions between one or more other modules described herein. The control module 55 sets parameters and settings for each module and component of the virtual environment module 32.

The illustrated virtual environment module 32 includes a communication module 57, such as a network card, system bus, or wireless communication module, and communicates with a computerized network. The communication module 57 provides communication capabilities, such as wireless communication, to the modules and components of the virtual environment module 32 and the components and other modules described herein. The communication module 57 provides communication between a wireless device, such as a mobile phone, and a computerized network and/or to facilitate communication between a mobile device and other modules described herein. The communication module 57 may have a component thereof that is resident on a user's mobile device or on a user's desktop computer.

The illustrated virtual environment module 32 includes a data storage module 59 in communication with the modules and components of the virtual environment module 32. The data storage module 59 collects and store data for each of the modules of the virtual environment module 32. The data storage module 59 is in communication with the various modules and components of the virtual environment module 32 and stores data transferred there through. The data storage module stores 59 data transferred through each of the modules of the virtual environment module 32, thereby updating the virtual environment module 32 with up to date data and real time user and product data. The data storage module 59 securely stores user data along with data transferred through the virtual environment module 32. Data storage modules may be databases and/or data files and the memory storage device may be, but is not limited to, hard drives, flash memory, optical discs, RAM, ROM, and/or tapes.

The illustrated virtual environment module 32 includes an avatar module 61 in communication with the modules and components of the virtual environment module 32. The avatar module 61 creates, manages and stores data in regards to a plurality of avatars navigating through a virtual environment. The avatar module 61 manages preferences, characteristics, settings, parameters, limitations, restrictions, appearances, etc. for each avatar navigating through a virtual environment. Non-limiting examples of an avatar module may include one or more of the following in communication with each other as appropriate to perform their functions: a user account management system, a programming object accessible to the overall system, and a library of display data (e.g. texture skins, motion scripts, polygon maps).

The illustrated virtual environment module 32 includes a virtual location module 65 in communication with the modules and components of the virtual environment module 32. The virtual location module 65 manages the location of a plurality of virtual objects displayed in a virtual environment. Administrators or store merchants may also manage the location of a plurality of virtual objects disposed within the virtual environment or within the virtual store. Non-limiting examples of a virtual location module may be a script or set of conditional programming statements that are periodically checked by the system that calculate locations and/or relational locations between objects within the virtual environment. Similar systems are used in multiplayer games and include hit-box modules and the like that calculate distances and perform functions (or refuse to perform functions) based on the calculated distances.

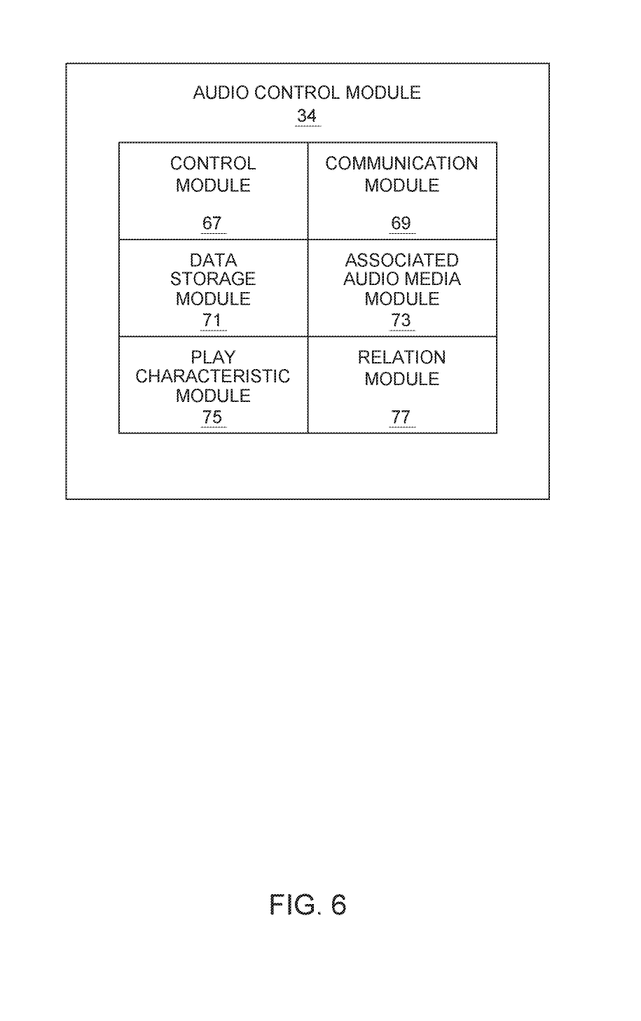

FIG. 6 is a module diagram of an audio control module, according to one embodiment of the invention. There is shown an audio control module 34 including a control module 67, a communication module 69, a data storage module 71, an associated audio media module 73, a play characteristic module 75, and a relation module 77.

The illustrated audio control module 34 manages audio media presented within a virtual environment created by the virtual shopping experience system. The audio control module 34 is in communication with a virtual environment module; wherein the audio control module 34 manages associated audio media with a plurality of virtual objects and a plurality of virtual locations; wherein the audio media module 34 plays audio media associated with the plurality of virtual objects in the virtual environment over a speaker with a play characteristic determined by a relation between a virtual location of an object associated with the associated media and a virtual location of an avatar of the user. The audio media includes audio files and streaming audio data.

The illustrated audio control module 34 includes a control module 67 that provides operational instructions and commands to the modules and components of the audio control module 34. The control module 67 is in communication with the modules and components of the audio control module 34 and provides managerial instructions and commands thereto. The source of such instructions/commands may be from one or more other modules described herein and/or through interactions between one or more other modules described herein. The control module 67 sets parameters and settings for each module and component of the audio control module 34.

The illustrated audio control module 34 includes a communication module 69, such as a network card, system bus, or wireless communication module, and communicates with a computerized network. The communication module 69 provides communication capabilities, such as wireless communication, to the modules and components of the audio control module 34 and the components and modules described herein. The communication module 69 provides communication between a wireless device, such as a mobile phone, and a computerized network and/or to facilitate communication between a mobile device and other modules described herein. The communication module 69 may have a component thereof that is resident on a user's mobile device or on a user's desktop computer.

The illustrated audio control module 34 includes a data storage module 71 in communication with the modules and components of the audio control module 34. The data storage module 71 collects and store data for each of the modules of the audio control module 34. The data storage module 71 is in communication with the various modules and components of the audio control module 34 and stores data transferred there through. The data storage module 71 stores data transferred through each of the modules of the audio control module 34, thereby updating the audio control module 34 with up to date data and real time user and product data. The data storage module 71 securely stores user data along with data transferred through the audio control module 34. Data storage modules may be databases and/or data files and the memory storage device may be, but is not limited to, hard drives, flash memory, optical discs, RAM, ROM, and/or tapes.

The illustrated audio control module 34 includes an associated audio media module 73 in communication with the modules and components of the audio control module 34. The associated audio media module 73 creates and manages audio media associated with a virtual object or virtual location. The associated audio media module 73 also tags and associates audio media to a virtual object or a virtual location. Non-limiting examples of an associated audio media module 73 may be an audio player (e.g. those provided under the brand names: Windows Media, RealPlayer, WordPress Audio Player, iTunes player, Winamp), an audio recorder (e.g. those provided under the brand names: Audacity, Moo0 Voice Recorder, GoldWave, Mixcraft, Wavepad, Blaze Media Pro, AV Music Morpher), an audio library management system (e.g. applications provided under the brand names: Rhapsody, Windows Media, Media Monkey, Winamp, jetAudio, Reaplayer, SoundTaxi), and/or scripts/objects/functions that may activate, manipulate, bridge, control, or modify one or more audio players/recorders and/or audio library management systems.

The illustrated audio control module 34 includes a play characteristic module 75 in communication with the modules and components of the audio control module 34. The play characteristic module 75 manages play characteristics associated with a virtual object or a virtual location. The play characteristic is selected from the group of characteristics consisting of: volume, pitch modulation, play speed, tone, pan, meter, gain, balance, and audio effects (dynamic based, frequency based, time based or otherwise) including but not limited to reverberation, fade, clipping, equalizer effects, mute effects, limiting, maximizing, expanding, distortion, wah-wah, compression, noise gating, delay, echo, phasing, and flanging. The play characteristic is also controlled and set up a user, and may play according to settings and parameters of each avatar within the virtual environment. Play characteristic modifications may be limited by start/stop times, duration, track/channel affected, user, region, and the like and combinations thereof. Non-limiting examples of a play characteristic module may be an audio recording/manipulation/production hardware/software such as but not limited to those sold under the brands: Audio Box, Studio One, Audacity, CamStudio, n-Track Studio, Cubase, Apple Logic Pro X, Sonar, Mixcraft, Pro Tools, Reason, Ableton Live, Samplitude Music Studio, Reaper, Edirol R-09, Korg MR-1, M-Audio Microtrack 24/96, Marantz PMD620, Olympus LS-10, Sony PCM-D50, Tascam GT-R1, Yamaha Pocketrak 2G, and Zoom H2.

The illustrated audio control module 34 includes a relation module 77 in communication with the modules and components of the audio control module 34. The relation module 77 manages the relation between a virtual location of an object associated with the associated audio media and a virtual location of an avatar of the user. The relation may be calculated as an inverse square of a total distance between a virtual location of an object associated with the associated audio media and a virtual location of an avatar of the user. The relation between a virtual location of an object associated with the associated audio media and a virtual location of an avatar of the user may include a determination as to whether each are in the same virtual zone. Non-limiting examples of relations include: single-axis distance, multi-axis distance (summed or actual), total distance (actual distance considering all axis), inverse square of a distance (one or more axis, summed or actual), inverse of a distance, inverse exponential (e.g. cubed, to the fourth power) of a distance, path distance (e.g. distances going around virtual objects/corners), exponential of a distance (e.g. squared, cubed), sums of distances, differences of distances, calculations based on distance relationships between a multiplicity of objects, and the like and combinations thereof. Non-limiting examples of a relation module may be include one or more scripts, functions, objects, apps and the like that are able to access virtual location information regarding a plurality of objects and then perform calculations/comparisons between that data to determine particular relations.

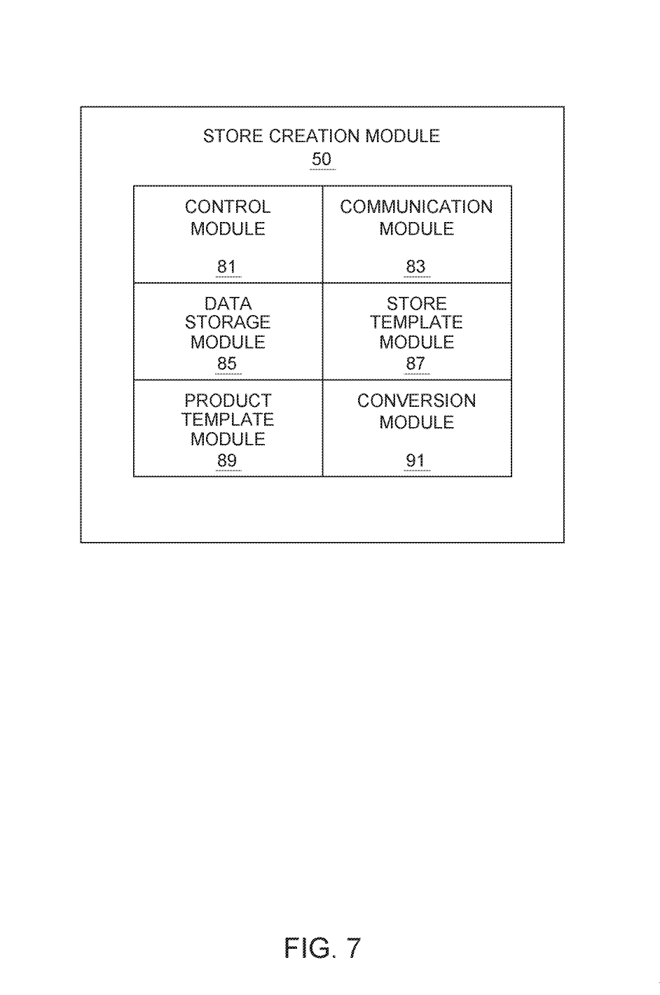

FIG. 7 is a module diagram of a store creation module, according to one embodiment of the invention. There is shown a store creation module 50 includes a control module 81, a communication module 83, a data storage module 85, a store template module 87, a product template module 89, and a conversion module 91.

The illustrated store creation module 50 enables a merchant to create a virtual store including virtual objects or products available for purchase by an avatar or user navigating through the virtual environment. The store creation module 50 creates a plurality of objects at virtual locations within the virtual environment; wherein the store creation module 50 converts 2D images to 3D representational images displayed as product avatars.

The illustrated store creation module 50 includes a control module 81 that provides operational instructions and commands to the modules and components of the store creation module 50. The control module 81 is in communication with the modules and components of the store creation module 50 and provides managerial instructions and commands thereto. The source of such instructions/commands may be from one or more other modules described herein and/or through interactions between one or more other modules described herein. The control module 81 sets parameters and settings for each module and component of the system.

The illustrated store creation module 50 includes a communication module 83, such as a network card, system bus, or wireless communication module, and communicates with a computerized network. The communication module 83 provides communication capabilities, such as wireless communication, to the modules and components of the store creation module 50 and other modules described herein. The communication module 83 provides communication between a wireless device, such as a mobile phone, and a computerized network and/or to facilitate communication between a mobile device and other modules described herein. The communication module 83 may have a component thereof that is resident on a user's mobile device or on a user's desktop computer.

The illustrated store creation module 50 includes a data storage module 85 in communication with the modules and components of the store creation module 50. The data storage module 85 collects and store data for each of the modules of the data storage module 85. The data storage module 85 is in communication with the various modules and components of the store creation module 50 and stores data transferred there through. The data storage module 85 stores data transferred through each of the modules of the store creation module 50, thereby updating the store creation module 50 with up to date data and real time user and product data. The data storage module 85 securely stores user data along with data transferred through the store creation module 50. Data storage modules may be databases and/or data files and the memory storage device may be, but is not limited to, hard drives, flash memory, optical discs, RAM, ROM, and/or tapes.

The illustrated store creation module 50 includes a store template module 87 in communication with the modules and components of the store creation module 50. The store template module manages and stores store templates for merchants to use to create and maintain their virtual store within the virtual environment. The store template module 87 provides display settings, product settings, object location settings, advertisement settings, marketing capabilities, etc. for the creation and maintenance of a virtual store within the virtual environment. Non-limiting examples of a store template module may include one or more template databases, data upload utilities, media libraries, templates, structured/relational databases, and the like and combinations thereof.

The illustrated store creation module 50 includes a product template module 89 in communication with the modules and components of the store creation module 50. The product template module manages and stores product or object templates for merchants to use to create and maintain their virtual product or virtual objects within the virtual store within the virtual environment. The product template module 89 provides product settings, product location settings, product advertisement settings, product marketing capabilities, etc. for the creation and maintenance of a virtual product or virtual object within a virtual store within the virtual environment. Non-limiting examples of a product template module may include one or more of template databases, data upload utilities, media libraries, templates, structured/relational databases, and the like and combinations thereof.

The illustrated store creation module 50 includes a conversion module 91 in communication with the modules and components of the store creation module 50. The conversion module 91 enables a merchant to convert 2D images to 3D representational images displayed as product avatars within the virtual store within the virtual environment. The conversion module 91 enables a merchant to upload a 2D image and converts the 2D image to a 3D representational image to be displayed throughout a virtual store within a virtual environment. Non-limiting examples of a conversion module may include one or more template databases, data upload utilities, media libraries, templates, structured/relational databases, rendering tools, 3D programming objects, and the like and combinations thereof.

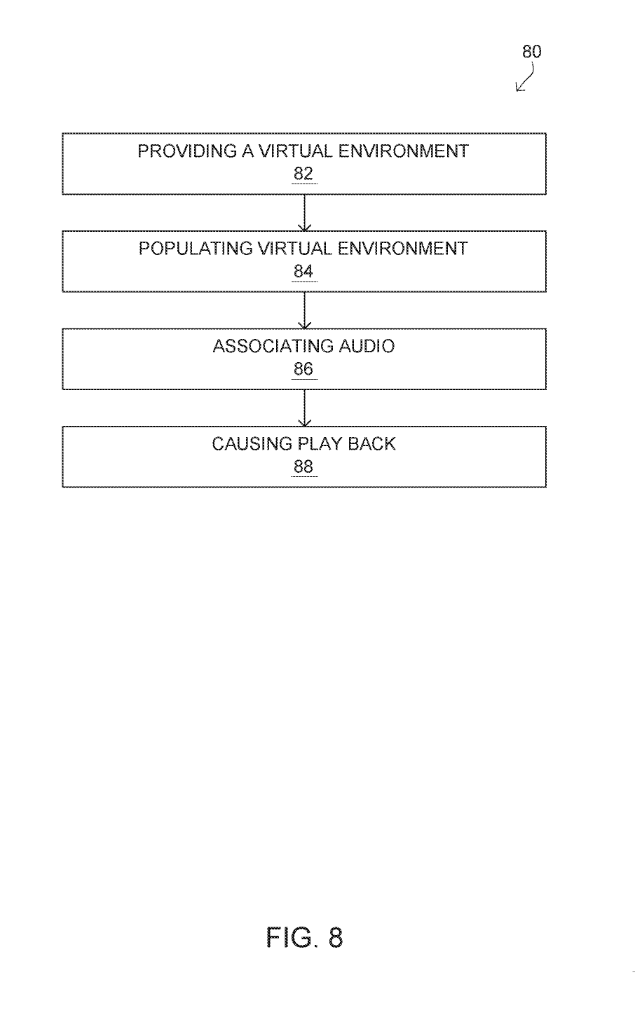

FIG. 8 is a flowchart of a method of providing a virtual shopping experience, according to one embodiment of the invention. There is shown a method of providing a virtual shopping experience 80 over a computerized network.

The illustrated method of providing a virtual shopping experience 80 over a computerized network. The method 80 includes the step of providing a virtual environment over a computerized network 82. The virtual environment is created and managed by the modules and components previously described above. A plurality of users are able to navigate therein each using an avatar by operation of a graphical user interface.

The method of providing a virtual shopping experience 80 includes the step of populating the virtual environment with a plurality of virtual objects at virtual locations 84. The plurality of virtual objects includes a plurality of user avatars and product avatars associated with a shopping cart module. The step of populating the virtual environment 84 includes the step of providing a store creation module that creates a plurality of objects at virtual locations. The store creation module converts 2D images to 3D representational images displayed as product avatars.

The method of providing a virtual shopping experience 80 includes the step of associating audio media with the plurality of virtual objects and the virtual locations thereby generating associated audio media 86. The audio media includes audio files and streaming audio data.

The method of providing a virtual shopping experience 80 includes causing associated audio media to play over a speaker with a play characteristic thereof determined by a relation between a virtual location of an object associated with the associated media and a virtual location of an avatar of the user 88. The play characteristics are selected from the group of characteristics consisting of: volume, pitch modulation, play speed, tone, and reverberation. The relation between a virtual location of an object associated with the associated audio media and a virtual location of an avatar of the user is an inverse square of a total distance there between. The relation between a virtual location of an object associated with the associated audio media and a virtual location of an avatar of the user is a determination as to whether each are in the same virtual zone.

### Prophetic Example 1

An avatar of a user approaches a virtual store in a virtual mall, as the avatar approaches the store, the system triggers playing an audio clip associated with the store once the avatar reaches a distance threshold and plays it at a low volume, the volume increasing exponentially as the distance between the avatar and the store (or entrance thereof) decreases.

### Prophetic Example 2

Two users whose user profiles include a “friend” connection have set a user configurable setting that increases the pitch of sound associated with and/or generated by their respective avatars (e.g. theme music, live audio from their respective headsets so that they can talk to each other) while maintaining a constant volume regardless of distance between the avatars so that they can have an audio cue with regard to their distance from each other within a virtual environment.

### Prophetic Example 3

A product object is generated by a merchant for the merchant's virtual store using tools described herein to generate the same. By operation of a template selected by the merchant during creation, the product object includes a setting within the system such that at a particular threshold sound is provided to users who are proximate the avatar of the product object, but the sound is distorted in some manner when so played to the user thereby generating a sense of mystery as to what the sound may actually be. The distortion effect diminishes with decreasing distance between the user avatar and the product avatar so that the user is attracted to come closer to the product avatar to get a clearer sense of what the sound may be.

### Prophetic Example 4

A script within a system, as described herein, causes a media file to play when two types of virtual objects (e.g. user avatar and user avatar, product and user avatar, product and product, product and store, store and accessory) come within a threshold distance from each other, but if the pair of objects includes a specific object or specific combination of objects, then a sound characteristic is varied with distance, thereby providing audio evidence of the existence of the specific object or combination of objects. Such could be utilized to identify a product object that is otherwise identical to other similar product objects but may trigger the grant of a prize, award, etc.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of providing a virtual shopping experience, comprising the steps of:
a) providing a virtual environment over a computerized network; wherein a plurality of users are able to navigate therein each using an avatar by operation of a graphical user interface;
b) populating the virtual environment with a plurality of virtual objects at virtual locations;
c) associating audio media with the plurality of virtual objects and the virtual locations thereby generating associated audio media; and
d) causing associated audio media to play over a speaker with a play characteristic thereof determined by a relation between a virtual location of an object associated with the associated media and a virtual location of an avatar of the user.

2. The method of claim 1, wherein the plurality of virtual objects include a plurality of user avatars and product avatars associated with a shopping cart module.

3. The method of claim 1, wherein the step of populating the virtual environment further includes the step of providing a store creation module that creates a plurality of objects at virtual locations.

4. The method of claim 1, wherein the audio media includes audio files and streaming audio data.

5. The method of claim 1, wherein the play characteristics is selected from the group of characteristics consisting of: volume, pitch modulation, play speed, tone, and reverberation.

6. The method of claim 3, wherein the store creation module converts 2D images to 3D representational images displayed as product avatars.

7. The method of claim 1, wherein the relation between a virtual location of an object associated with the associated audio media and a virtual location of an avatar of the user is an inverse square of a total distance there between.

8. The method of claim 1, relation between a virtual location of an object associated with the associated audio media and a virtual location of an avatar of the user is a determination as to whether each are in the same virtual zone.

9. A method of providing a virtual shopping experience, comprising the steps of:
a) providing a virtual environment over a computerized network; wherein a plurality of users are able to navigate therein each using an avatar by operation of a graphical user interface;
b) populating the virtual environment with a plurality of virtual objects at virtual locations; wherein the plurality of virtual objects include a plurality of user avatars and product avatars associated with a shopping cart module;
c) associating audio media with the plurality of virtual objects and the virtual locations thereby generating associated audio media; and
d) causing associated audio media to play over a speaker with a play characteristic thereof determined by a relation between a virtual location of an object associated with the associated media and a virtual location of an avatar of the user.

10. The method of claim 9, wherein the step of populating the virtual environment further includes the step of providing a store creation module that creates a plurality of objects at virtual locations.

11. The method of claim 10, wherein the audio media includes audio files and streaming audio data.

12. The method of claim 11, wherein the play characteristics is selected from the group of characteristics consisting of: volume, pitch modulation, play speed, tone, and reverberation.

13. The method of claim 12, wherein the store creation module converts 2D images to 3D representational images displayed as product avatars.

14. The method of claim 13, wherein the relation between a virtual location of an object associated with the associated audio media and a virtual location of an avatar of the user is an inverse square of a total distance there between.

15. The method of claim 14, relation between a virtual location of an object associated with the associated audio media and a virtual location of an avatar of the user is a determination as to whether each are in the same virtual zone.

16. A system of providing a virtual shopping experience, comprising:
a) a virtual environment module over a computerized network; wherein a plurality of users are able to navigate an virtual environment each using an avatar by operation of a graphical user interface;
b) a virtual object module in communication with the virtual environment module; wherein the virtual object module manages a plurality of virtual objects displayed in the virtual environment; wherein the plurality of virtual objects include a plurality of user avatars and product avatars associated with a shopping cart module;
c) a virtual location module in communication with the virtual environment module; wherein the virtual location module manages the location of the plurality of virtual objects displayed in the virtual environment; and
d) an audio control module in communication with the virtual environment module; wherein the audio control module manages associated audio media with the plurality of virtual objects and the virtual locations; wherein the audio media module plays audio media associated with the plurality of virtual objects in the virtual environment over a speaker with a play characteristic determined by a relation between a virtual location of an object associated with the associated media and a virtual location of an avatar of the user; wherein the audio media includes audio files and streaming audio data.

17. The system of claim 16, further comprising a store creation module that creates a plurality of objects at virtual locations within the virtual environment; wherein the store creation module converts 2D images to 3D representational images displayed as product avatars.

18. The system of claim 17, wherein the play characteristic is selected from the group of characteristics consisting of: volume, pitch modulation, play speed, tone, and reverberation.

19. The system of claim 13, wherein the relation between a virtual location of an object associated with the associated audio media and a virtual location of an avatar of the user is an inverse square of a total distance there between.

20. The system of claim 14, relation between a virtual location of an object associated with the associated audio media and a virtual location of an avatar of the user is a determination as to whether each are in the same virtual zone.
